(19) United States
(12) Patent Application Publication
(10) Pub. No.: US 2003/0075002 A1
(43) Pub. Date: Apr. 24, 2003

(54) Extendable Handcycle pedal

(76) Inventor: Christopher J. Peterson, Tierra Verde, FL (US)

Correspondence Address: CALFEE HALTER & GRISWOLD, LLP, 800 SUPERIOR AVENUE, SUITE 1400, CLEVELAND, OH, 44114, US

(21) Appl. No.: 10/271,811

(22) Filed: Oct. 16, 2002

Related U.S. Application Data
(60) Provisional application No. 60/348,157, filed on Oct. 19, 2001.

(51) Int. Cl. B62K 21/12

(52) U.S. Cl. 74/551.1

(57) ABSTRACT

A hand pedal assembly (10) for a handcycle (12) having a drive sprocket (24) rotatable about an axis (26) and a hand crank (32) connected for movement with the drive sprocket, includes a support member (40) adapted to be secured to the hand crank for movement with the hand crank. A hand pedal (50) is connected with the support member (40) for movement relative to the support member in a first direction (70) parallel to the axis (26) and away from the hand crank (32) and a second direction (72) parallel to the axis and toward the hand crank to place the hand pedal in a plurality of operating positions. A mechanism (60) secures the hand pedal (50) to the support member (40) in any selected one of the plurality of operating positions.

### BACKGROUND OF THE INVENTION

1. Technical Field

The present invention relates to handcycles and, in particular, to a hand pedal assembly for a handcycle.

2. Description of the Prior Art

Handcycles are self-propelled wheeled vehicles that are set in motion by the force of the rider's hands and arms. Handcycles are an important means of transportation and recreation, particularly for individuals who desire to exercise their arms or for individuals who do not have the use of their legs. One important feature of handcycles is the hand pedals through which the rider provides a force that sets the handcycle in motion. The handcycle includes two hand pedals that are attached to hand cranks on opposite sides of a drive sprocket.

Typically, the rider sits in a seat on the handcycle and grasps one hand pedal with each hand. By moving the hand pedals, the rider causes rotation of the attached drive sprocket and turning of an attached chain. The chain is also connected with a driven sprocket that is attached to the front wheel of the handcycle. Therefore, when the rider provides a force that moves the hand pedals, the chain causes rotation of the front wheel and sets the handcycle in motion.

Since the hand pedals are the point at which the rider provides the force that moves the handcycle, it is important for the hand pedals to function in an efficient manner. Hence, a need exists for an efficient hand pedal system.

### SUMMARY OF THE INVENTION

The present invention relates to a hand pedal assembly for a handcycle having a drive sprocket rotatable about an axis and a hand crank connected for movement with the drive sprocket. The hand pedal assembly comprises a support member adapted to be secured to the hand crank for movement with the hand crank. A hand pedal is connected with the support member for movement relative to the support member in a first direction parallel to the axis and away from the hand crank and a second direction parallel to the axis and toward the hand crank to place the hand pedal in a plurality of operating positions relative to the hand crank. The hand pedal assembly also includes a mechanism for securing the hand pedal to the support member in any selected one of the plurality of operating positions.

### BRIEF DESCRIPTION OF THE DRAWINGS

The foregoing and other features of the present invention will become apparent to one skilled in the art to which the present invention relates upon consideration the following description of the invention with reference to the accompanying drawings, in which:

FIG. 1 is a side elevational view of a handcycle including a hand pedal assembly constructed in accordance with the present invention;

FIG. 2 is an exploded view of the hand pedal assembly of FIG. 1;

FIG. 3 is an elevational view, partially in section, showing a portion of the handcycle of FIG. 1 including a drive sprocket, two hand cranks, and two hand pedal assemblies; and

FIG. 4 is a sectional view of one of the hand pedal assemblies of FIG. 3, taken along line 4-4 of FIG. 3.

### DETAILED DESCRIPTION OF THE INVENTION

The present invention relates to handcycles and, in particular, to a hand pedal assembly for a handcycle. The present invention is applicant to different hand pedal assembly constructions. As representative of the present invention, FIG. 1 illustrates a hand pedal assembly 10 that forms part of a handcycle 12.

The handcycle 12 (FIG. 1) includes a frame 14. The frame 14 supports for rotation a front wheel 16 and one or more back wheels 18 of the handcycle 12. The frame 14 also supports a seat 20 on which an operator of the handcycle 12 can sit.

The frame 14 includes an upwardly projecting fork 22. The fork 22 supports a drive sprocket 24 for rotation about a drive axis 26. The drive sprocket 24 is connected by a drive chain 28 to a driven sprocket 30. The driven sprocket 30 is supported for rotation with the front wheel 16 of the handcycle 12. Rotation of the drive sprocket 24 about the drive axis 26 causes the drive chain 28 to transmit force to the driven sprocket 30 to rotate the front wheel 16 and, thereby, to propel the handcycle 12.

The handcycle 12 includes a pair of hand cranks 32 that are fixed for rotation with the drive sprocket 24 about the drive axis 26. The two hand cranks 32 are identical to each other. The two hand cranks 32 are shown as being 180° apart around the axis 26. It should be understood that the invention is applicable to cycles having a more typical arrangement of hand cranks that are aligned with each other instead of being 180° apart.

Each one of the hand cranks 32 has an inner end portion 34 that is fixed for rotation with the drive sprocket 24. Each one of the hand cranks 32 also has an outer end portion 36 with an internally threaded opening 38 that extends parallel to the drive axis 26, at a location spaced radially outward from the drive axis. The outer end portion 36 of the hand crank 32 revolves about the drive axis 26 as the drive sprocket 24 rotates about the drive axis.

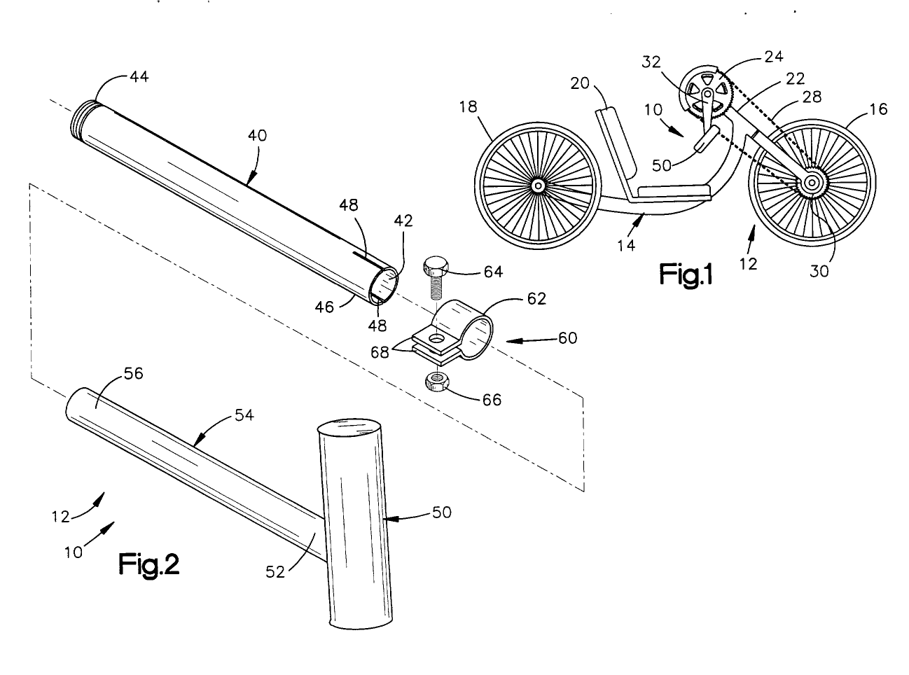

The hand pedal assembly 10 (FIGS. 2-4) includes a support tube or support member 40. The support member 40 is adapted to be secured to the hand crank 32 for movement with the hand crank. In the illustrated embodiment, the support member 40 has a tubular configuration with an axially extending central opening 42. The support member 40 has an inner end portion 44 that is externally threaded to engage the internally threaded outer end portion 36 of the hand crank 32. The support member 40 could have a different construction than illustrated.

The support member 40 has an outer end portion 46. Two slots 48 are formed in the outer end portion 46 at diametrically opposite locations. The slots 48 facilitate radially inward deformation, or squeezing, of the outer end portion 46 of the support member 40.

The hand pedal assembly 10 also includes a hand pedal 50. The hand pedal 50 is a member that is manually engageable by a hand of a rider of the handcycle 12 to transmit driving force to the handcycle.

The hand pedal assembly 10 also includes a mounting bar 54. The hand pedal 50 is supported for rotation on an outer end portion 52 of the mounting bar 54, in a known manner (not shown) such as by an internal bearing. The mounting bar 54 has an opposite inner end portion 56 that is slidably received in the central opening 42 in the support tube 40. The mounting bar 54 may be a tubular member as shown, or may alternatively be a solid member. Also, the mounting bar 54 could be tubular and slidably receive the support tube 40. In addition, the rotational support (bearings, for example) for the hand pedal 50 could be located at the area of connection between the support tube 40 and the hand crank 32.

The hand pedal assembly 10 also includes a mechanism for releasably securing the hand pedal 50 to the support member 40. In the illustrated embodiment, the mechanism is a releasable clamp 60. The securing mechanism could have a different construction. The clamp 60 includes a sleeve 62, a bolt 64, and a nut 66. The sleeve 62 is configured as a split sleeve that extends around the outer end portion 46 of the support tube 40. The bolt 64 extends through radially extending flanges 68 on the ends of the split sleeve 62. The nut 66 is screwed on the bolt 64.

Tightening of the nut 66 on the bolt 64 results in tightening of the split sleeve 62 on the outer end portion 46 of the support tube 40. This tightens the outer end portion 46 of the support tube 40 radially inwardly on the inner end portion 56 of the mounting bar 54. As a result, the hand pedal 50 is connected with the support tube 40 for rotation with the support tube and the hand crank 32 about the drive axis 26. Application of force to the hand pedal 50 by a rider of the handcycle 12 therefore results in transmission of force through the mounting bar 54 and the support tube 40 to the hand crank 32, to drive the handcycle 12.

The hand pedal assembly 10 is adjustable, or extendable, by virtue of its construction as described above. Specifically, the mounting bar 54 including its outer end portion 52 is slidable a first direction 70 away from the hand crank 32, and in an opposite second direction 72 toward the hand crank. The first and second directions 70 and 72 extend parallel to the drive axis 26. Such sliding movement places the hand pedal 50 in a plurality of different operating positions relative to the hand crank 32, in a direction parallel to the axis 26.

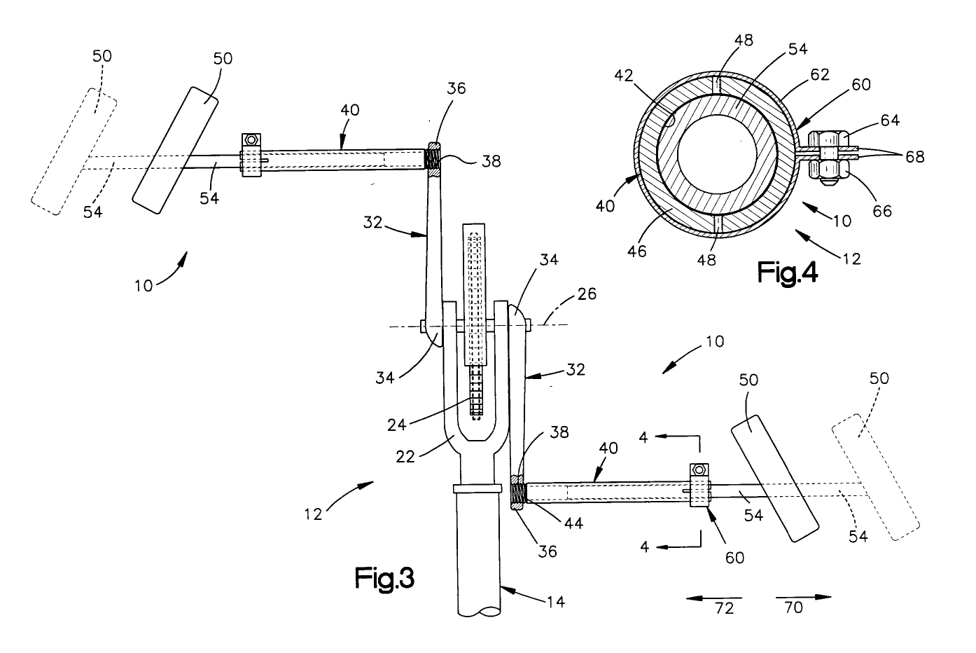

As one example, the hand pedal 50 is illustrated in solid lines in FIG. 3 in a first operating position relative to the hand crank 32. The hand pedal 50 is relatively close to the hand crank 32, that is, at a first distance from the hand crank.

As another example, the hand pedal 50 is illustrated in dashed lines in FIG. 3 in a second operating position moved relative to the hand crank 32. The hand pedal 50 is farther from the hand crank 32, that is, in the first direction 70 away from the hand crank. The hand pedal 50 is located at a second distance from the hand crank greater than the first distance.

When substantially the entire length of the mounting bar 54 is inserted into the opening 42 in the support tube 40, the hand pedal 50 is said to be in an “unextended” position. When each hand pedal 50 is disposed in the unextended position, the hands of the rider of the handcycle 12 are relatively close to one another.

When an intermediate length of the mounting bar 54 is inserted into the opening 42 in the support tube 40, the hand pedal 50 is said to be in a “partially extended” position. When each hand pedal 50 is disposed in the partially extended position, the hands of the rider are farther apart from one another than when the pedals 50 are in the unextended position.

When only a minimum length of the mounting bar 54 is inserted into the 20 opening 42 in the support tube 40, the hand pedal 50 is said to be in a “fully extended” position. When each hand pedal 50 is disposed in the fully extended position, the hands of the rider are farther apart from one another than when the hand pedals are in the partially extended position.

Hence, by slidably adjusting the hand pedal assembly 10 (moving the mounting bar 54 telescopically in and out of the support tube 40), the rider can adjust the hand pedals 50 to an infinite number of locations with respect to the hand crank 32 and the drive sprocket 24. This allows the hands of the rider to be different distances apart. The extendable hand pedal 50, therefore, provides custom adjustment and allows the rider's hands and arms to be placed in a comfortable and efficient position.

From the above description of the invention, those skilled in the art will perceive improvements, changes, and modifications in the invention. Such improvements, changes, and modifications within the skill of the art are intended to be included within the scope of the appended claims.

Having described the invention, I claim:

1. A hand pedal assembly for a handcycle having a drive sprocket rotatable about a drive axis and a hand crank connected for movement with the drive sprocket, said hand pedal assembly comprising:
a support member adapted to be secured to the hand crank for movement with the hand crank;
a hand pedal connected with said support member for movement relative to said support member in a first direction parallel to the drive axis and away from the hand crank and a second direction parallel to the drive axis and toward the hand crank to place said hand pedal in a plurality of operating positions relative to the hand crank; and
a mechanism for securing said hand pedal to said support member in any selected one of said plurality of operating positions.

2. A hand pedal assembly as set forth in claim 1 wherein said hand pedal is connected with said support member for sliding movement relative to said support member in the first and second directions.

3. A hand pedal assembly as set forth in claim 2 wherein said hand pedal assembly includes a mounting bar connected with said hand pedal, and wherein a first one of said mounting bar and said support member has a tubular configuration extending generally parallel to the drive axis and a second one of said mounting bar and said support member has a portion slidably received within said tubular first one of said hand pedal and said support member.

4. A hand pedal assembly as set forth in claim 2 wherein said mounting bar has a portion slidably received within said support member.

5. A hand pedal assembly as set forth in claim 1 wherein said mechanism for securing said hand pedal to said support member in any selected one of said plurality of operating positions comprises a clamp.

6. A hand pedal assembly as set forth in claim 5 wherein said clamp is operative to exert radially inwardly directed clamping force on said support member.

7. A hand pedal assembly for a handcycle having a drive sprocket rotatable about an axis and a hand crank connected for movement with the drive sprocket, said hand pedal assembly comprising:
a hand pedal for manual engagement by an operator of the handcycle;
means for supporting said hand pedal at a plurality of different distances from the hand crank in a direction parallel to the axis; and
means for securing said hand pedal at any selected one of the plurality of different distances from the hand crank.

8. A hand pedal assembly as set forth in claim 7 wherein said means for supporting said hand pedal at a plurality of different distances from the hand crank comprises first and second members in sliding engagement with each other.

9. A hand pedal assembly as set forth in claim 8 wherein said first member is fixable to the hand crank and said second member supports said hand pedal for rotation relative to said first member.

10. A hand pedal assembly as set forth in claim 9 wherein said first member has a tubular configuration and said second member is slidably received in said first member.

11. A hand pedal assembly as set forth in claim 7 wherein said means for securing said hand pedal at any selected one of the plurality of different distances from the hand crank comprises a releasable clamp.

12. A hand pedal assembly for a handcycle having a drive sprocket rotatable about an axis and a hand crank connected for movement with the drive sprocket, said hand pedal assembly comprising:
a tubular support member having a first end portion adapted to be secured to the hand crank for movement with the hand crank and having an opposite second end portion;
a hand pedal;
a mounting bar connected with said hand pedal and slidably received in said tubular support member for enabling sliding movement of said hand pedal relative to said support member in a first direction parallel to the axis and away from the hand crank and a second direction and parallel to the axis and toward the hand crank to place said hand pedal in a plurality of operating positions relative to the hand crank; and
a clamp for clamping together said mounting bar and said support member in any selected one of said plurality of operating positions.

13. A hand pedal assembly as set forth in claim 12 wherein said clamp clamps said support member radially inward on said mounting bar.

14. A hand pedal assembly as set forth in claim 13 wherein said support member has at least one slot to facilitate clamping of said support member on said mounting bar.

15. A hand pedal assembly as set forth in claim 12 wherein said hand pedal is supported on said mounting bar for rotation relative to said mounting bar.
